(19) United States
(12) Patent Application Publication
(10) Pub. No.: US 2015/0170103 A1
(43) Pub. Date: Jun. 18, 2015

(54) Network-based referral system and method for recruitment

(71) Applicant: Adactin Group Pty Ltd, Parramatta (AU)

(72) Inventors: Navneesh Garg, Parramatta (AU); Sapna Bhatia, Parramatta (AU)

(21) Appl. No.: 14/559,482

(22) Filed: Dec. 3, 2014

(30) Foreign Application Priority Data
Dec. 13, 2013 (AU) 2013904861

(51) Int. Cl. G06Q 10/10

(52) U.S. Cl. CPC G06Q 10/1053

(57) ABSTRACT

A network based referral system for recruitment, comprising: a job profile corresponding to inputs by a first user of said system; an applicant description module which includes data from an applicant description profile corresponding to characteristics of a second user and an applicant referred to the system by the second user; and a database for storing a plurality of said job profiles and for receiving said applicant description profile over said network and for matching characteristics of said applicant description profile with corresponding characteristics of said job.

### CROSS-REFERENCE TO RELATED APPLICATION

This application claims the benefit of Australian Provisional application no. 2013904861 filed on Dec. 13, 2013, the entire document of which is incorporated herein by reference.

### TECHNICAL FIELD

The present invention relates to a network based referral system and method for recruitment.

### BACKGROUND

Previously, there have been several well-known online recruitment systems for matching job seekers or candidates with employment or recruitment opportunities. For example, the websites such as: www.seek.com.au; www.monster.com; and www.naukri.com. These example websites typically allow candidates to upload their resumes and apply for jobs or employment using an online portal system.

However, these earlier systems generally fail to reward people who refer job opportunities onto appropriately qualified job seekers. Additionally, there is no incentive to refer job opportunities to other people who may be interested in the particular job opportunity.

Further, there have also been several inventions aimed at improving referral networks associated with online job portals. An example is PCT Published Applications No. WO2008019711 and WO2011140259, which describe network based referral systems for recruitment. However, in these disclosed systems, the candidate's profile and resume are in effect automatically garnered from social media websites (such as Facebook™). The disclosed systems then automatically refer people based on linkages from the social media sites and generally fail to compensate the referring party. Further, these systems rely on third party websites to generate contact lists and this type of system may be refer the best possible candidate for each job opportunity.

Many previous systems aim to improve the profiling of candidates but ignore the possible advantages of developing a referral tree or a network of referral contacts. For example, PCT Published Application No. WO1999017242, discloses an improved profiling system for job seeking and job matching websites but the disclosed systems generally fail to make efforts to improve the referral system to increase the number of appropriately skilled people viewing the job opportunity.

Any discussion of the prior art throughout the specification should in no way be considered as an admission that such prior art is widely known or forms part of common general knowledge in the field.

### SUMMARY

### Problems to be Solved

It is an aim and objective of the present invention to provide an improved network based referral system and method suitable for use in relation to the field of employment and recruitment, wherein users of the system or method may be able to refer other users to the system or method.

It is an object of the present invention to overcome or ameliorate at least one of the disadvantages of the prior art, or to provide a useful alternative.

### Means for Solving the Problem

A first aspect of the present invention may relate to a network based referral system for recruitment, comprising: a job profile corresponding to inputs by a first user of said system; an applicant description module which includes data from an applicant description profile corresponding to characteristics of an second user and an applicant referred to the system by the second user; and a database for storing a plurality of said job profiles and for receiving said applicant description profile over said network and for matching characteristics of said applicant description profile with corresponding characteristics of said job.

Preferably, the system is adapted to allow the second user to invite an applicant to be linked to the application description profile. The preferred system may be adapted to accept job applications from either second user or applicant.

The characteristics may include: contact details, a skills list, an expertise list, and a testing result profile; and the testing result profile may be derived from results of a standardised testing procedure relevant to a skillset as undertaken by the respective second user or applicant.

Preferably, the application description profile includes a referral tree that includes data on a plurality of applicants known to the second user and referred to the system by the second user.

The system may also include an authentication procedure to verify the relationship between the second user and applicant. Preferably, the applicant is a third party and not the second user.

The system may provide consideration to a second user wherein an applicant linked to the application description profile is employed by the first user. The preferred consideration payable to a second user is in the form selected from the following group: points, credits, currency or remuneration prizes.

The system may be adapted to allow the applicant to invite a second tier applicant to be linked to the application description profile, and further the system may be adapted to accept job applications from the second tier applicant. The preferred application description profile may also include a referral tree that includes data on a plurality of second tier applicants known to at least one applicant or the second user and referred to the system by the at least one applicant or the second user.

The preferred system may provide consideration to a second user and the applicant wherein the second tier applicant linked to the application description profile is employed by the first user. Further, the system may provide consideration to a second user and the applicant at a differentiation rate.

Preferably, the system may be adapted to allow the second tier applicant to invite a third tier applicant to be linked to the application description profile.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 depicts schematically part of a first embodiment of the present invention and demonstrates example components of a preferred system;

FIG. 2 depicts a candidate interface for use with the first embodiment;

FIG. 3 depicts a flowchart for use with the skill assessor interface as part of the first preferred embodiment;

FIG. 4 depicts a flowchart for use with a recruiter interface as part of the first preferred embodiment;

FIG. 5 depicts an administrator interface for use the first preferred embodiment;

FIG. 6 depicts a referral tree or candidate tree for use with the first preferred embodiment;

FIG. 7 depicts a skill assessment score calculator methodology for use with the first preferred embodiment;

FIG. 8 depicts a search methodology for use with the first preferred embodiment;

FIG. 9 depicts a candidate availability checking methodology for use with the first preferred embodiment;

FIG. 10 depicts an example of a flowchart that may be used to calculate an SAS score for use with the first preferred embodiment;

FIG. 11 depicts a consideration calculator interface for use with the first preferred embodiment; and

FIG. 12 depicts an improved interface to that shown in FIG. 11.

### DETAILED DESCRIPTION

Preferred embodiments of the invention will now be described with reference to the accompanying drawings and non-limiting examples.

In this specification, the terms “network tree”, “referral tree”, and “candidate tree” all refer to a network of people referred to the preferred system and entered as tiers of candidates or applicants, wherein each person has been invited into the system by the layer or tier above their location in the tree. Further, the terms “candidate” and “applicant” are synonymous. Further, the terms “employer” and “recruiter” both refer to person(s) who are likely to use the embodiments to list job openings for candidates.

According a first preferred embodiment of the present invention, a system or method is provided wherein the system or method comprises a network based and enabled system of linking candidates with employers or recruiters. The system provides an online web portal acting through an internet enabled web server to provide a means to link candidates with job openings posted by employers on the system.

Preferably, the system may include a referral tree within which candidates may refer other potential candidates to the system and encourage them to also apply for job openings or opportunities.

The system is generally adapted to operate on a server including a database of profiles of candidates and employers/recruiters. The database may also include selected data about these groups and people. The system is adapted to be engaged by users through a web browser interface.

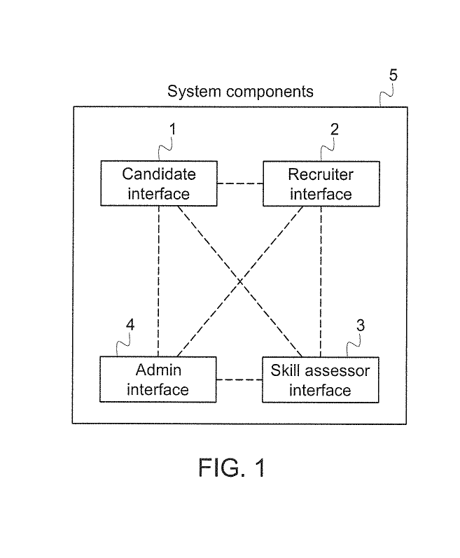

Preferably, the first preferred embodiment may include a system with at least four distinct interfaces as defined by the following list: administration interface 4, candidate interface 1, recruiter interface 2, and skill assessor interface 3. Some of the basic system components of the distinct interfaces are shown or depicted in FIG. 1. It is noted that preferably each one of the shown interfaces may be selectively connected to databases or tables recording data attributed to each interface. Each interface includes a plurality of data types to record information and data about regarding the relevant type of user.

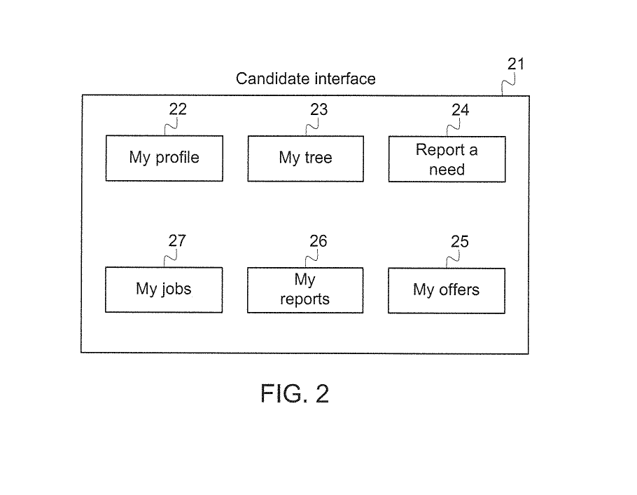

The candidate interface is depicted in FIG. 2, wherein this interface 21 is preferably used by the candidate to setup a profile. This profile may save the candidate's resumes for different skills and keywords, enter sales lead, look at his referral tree, redeem points and look at his point summary. The interface 21 may preferably include several regions or subtype interface screens available for the candidate or user to setup and engage. These regions include: My Profile area 22, My Tree area 23, Report A Need area 24, My Jobs area 27, My Reports area 26, and My Offers 25.

In respect of the My Profile area 22, candidate may: setup or upload his or her skills to the system, upload his or her profile and setup keywords relating to his or her skills. He/she may also preferably be able to enter the job categories relative them and may also provide skill rating on a scale of 10. Candidate may also provide his personal details, address, email, social media contact details, country, bank details and tax file number (or social security number) or other relevant information or data about the candidate for completing his or her registration.

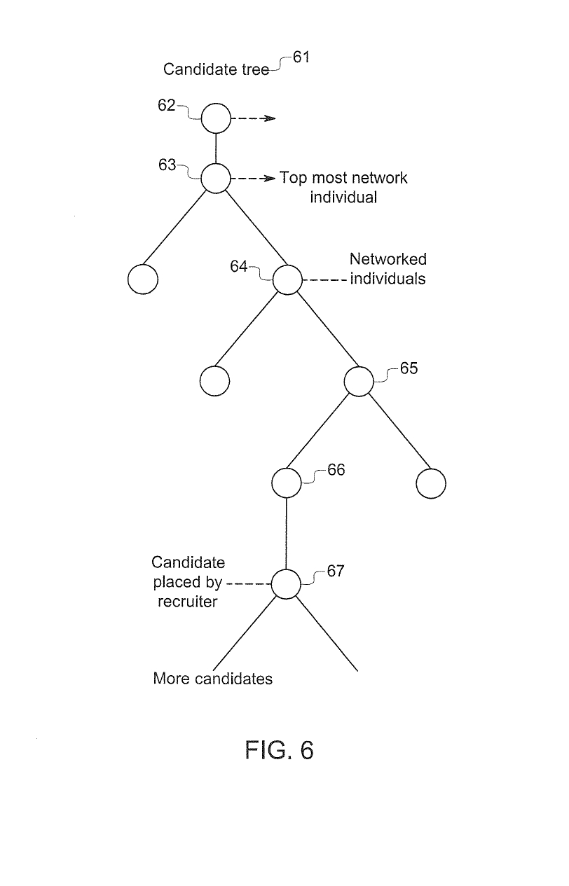

In respect of the My Tree area 23, the candidate may view his or her referral tree which is described in greater detail in relation to FIG. 6. This area may generally include further subtype areas labelled Treeview area (which allows the candidate to view their network or referral tree), Refer A Friend area (which allows the candidate to instruct the system to send email notifications or invites to friend or acquaintances of the candidate, if they accept they are joined to the aforementioned referral tree), statistics area (which allows the candidate to view various statistics about their own job applications or applications made by people in their referral tree).

In respect of the Report A Need area 24, the candidate may be allow to report a sales need to system. Once a need is reported it is relayed (preferably by email) to the Administrator interface who allocate it to recruiter. Preferably, the candidate can keep a track of status of his or her needs that are reported to the system.

In respect of the My Jobs area 27, this area may allow the candidate to view job opportunities referred by other people or search for job opportunities that significantly match the candidate's profile. This area may also allow the candidate to apply for job opportunities and send their contact details to recruiters or employers. Also in this area, the candidate may be able to view the progress and status of current job applications that they have been applied for. This subtype area is named “Jobsflash”.

In respect of the My Reports area 26, the candidate is preferably allowed by the system to obtain several reports from the system using the web portal. These reports may include: My Tree report which may show a report on next tier candidates referred by the candidate to the system; MyPoint report which is a report based on the current or chosen financial year and preferably demonstrates points or credits gathered by candidate as part of the later described consideration scheme; and My Report A Need report which is a report that generates or shoes the status and summary of sales lead reported by candidate or referred by the candidate.

In respect of the My Offers area 25, the candidate is allowed by the system to view offers made to them and/or to the next tier of referred candidates. Based on points or credits gathered by candidate he or she may be able to redeem the points or credits on either training services or cash voucher at predetermined time internals. The system may be integrated with other commercial training services provider whose vouchers they can redeem from within the system using the points or credits.

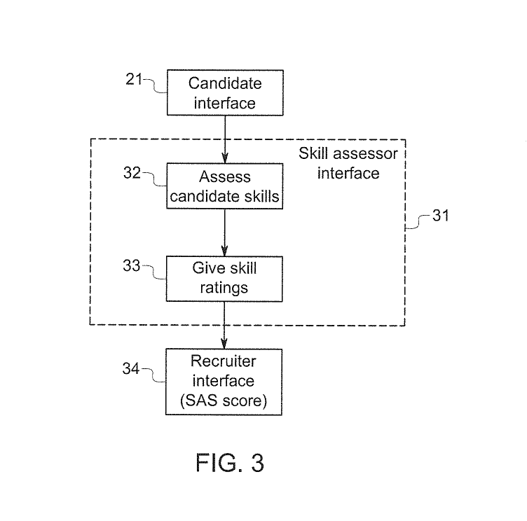

FIG. 3 depicts further information and detail regarding the Skill Assessor Interface 31, which can be chosen from the Candidate's Interface 21. Within the Skill Assessor Interface 31, a process is shown wherein candidates may engage with the system to assess the candidate's skills in a particular chosen area or field 32 and then the system may generate a skill rating 33 based on the testing results of the candidate. The skill rating is converted to a SAS score (this is a standardised score from a predetermined maximum mark e.g. out of 100) and the SAS score is then relayed to the recruiter or employer.

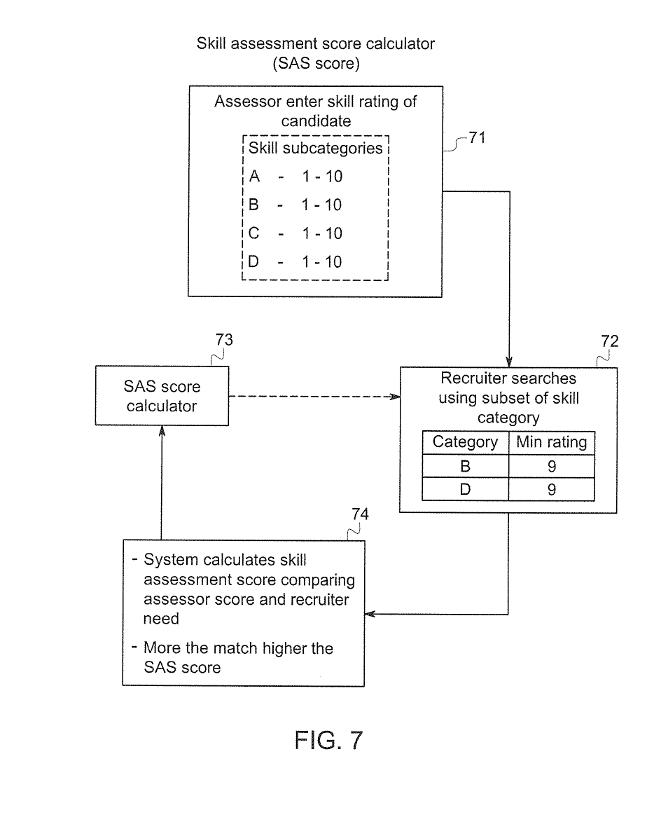

Alternatively, an external skilled assessor may independently interview a candidate independently and update the skill assessor interface with rating of candidate on each of the skills. Preferably, this is skill assessment is conducted on a confidential basis available only to permitted users. This information will be used by recruiter and system to automatically calculate skill assessment score (SAS score) of relevant candidate based on needs. An example of how the SAS score may be calculated is described in further detail below and with reference to FIG. 7.

Along with the candidate skill assessment feedback of existing candidate will also be updated in the system in form of rating and a quote. Candidate with a generally good feedback assessment will help them get improve their Candidate Score value which is calculated based on SAS score, resource cost and feedback. Preferably, the skill assessment of candidate may be completed every 6 months or some other predetermined time interval.

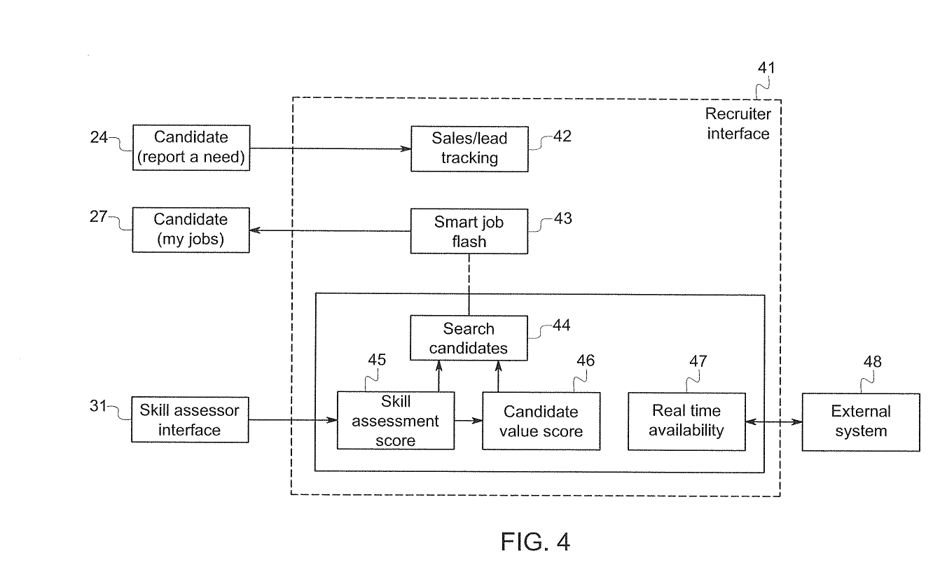

The Recruiter Interface 41 is depicted in greater detail in FIG. 4. The Recruiter Interface 41 may also be named the Franchise Interface. Preferably, the Recruiter Interface 41 may be engaged through the Report a Need area 24 in the Candidate interface, My Jobs Area 27, or Skill Assessor Interface 31. The Recruiter Interface 41 may function to allow a recruiter or employer to engage with the candidates and monitor status and progress through the system.

Preferably, the Recruiter Interface 41 may include a Search Candidates area 44. Area 44 may allow the recruiter to search for candidates based on any of the following combinations of search types including: costing, keywords, skills, SAS Score 45, Candidate Value Score 46 and other needs. Automatic skill assessment algorithm would find out list of relevant candidates based on Skill Assessment score 45. Preferably, the System may also confirm or verify candidates availability based on real time availability algorithm 47 or data/information added by candidates in their respective profile.

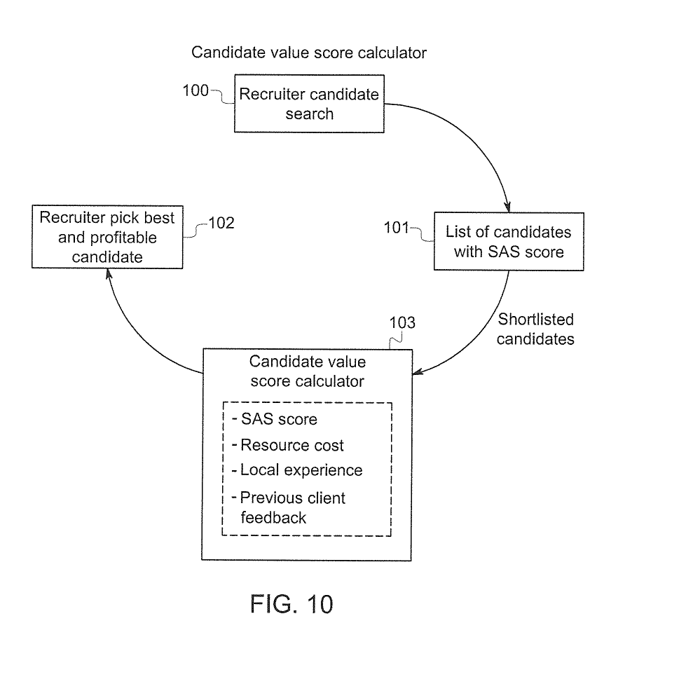

System may also automatically provide Candidate Value Score 46 for each of the candidate based on his SAS score, client feedback and daily rate. Preferably, the Candidate Value Score may be calculated as per the flowchart depicted in FIG. 10. Further details of the Candidate Value Score are further described within the accompanying description to FIG. 10.

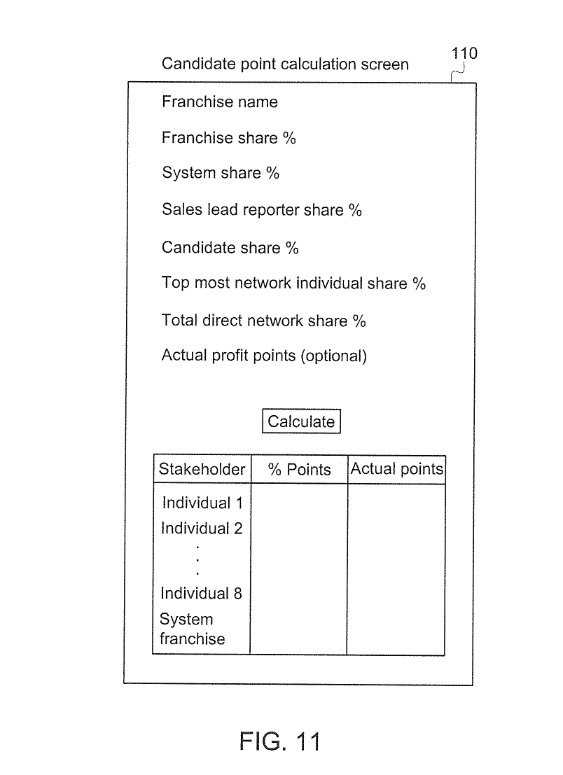

The recruiter interface 41 also may engage the system to calculate points/credits to be awarded to referring people. Preferably, these points or credits will be calculated based on Point or Credit Calculation Algorithm (this algorithm is described in greater detail in relation to FIG. 11). The system will report to the recruiter the exact quanta of points or credits issued to the referring people or persons and the recruiter will be aware how much points will each of the participants in the system will be issued.

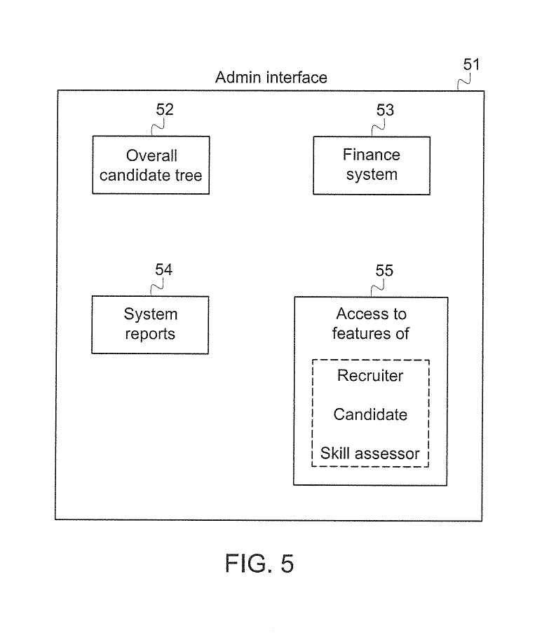

The Sales lead tracking module or area 42, may allow the recruiter to gain system reports relating to the following areas: Customer relationship management interface to track all the leads generated by the system; all the leads assigned to recruiter/franchises can be tracked; and point/credit calculation and invoice creation, which the system may to a finance or accounting system 53 (as described in respect of FIG. 5).

The Job Flash area or module 43, may allow the recruiter to “flash job” or post to entire list of candidates in that job category. The recruiter may also have access to Smart Job Flash which may allow them to send job opportunities to only relevant candidates or candidates shortlisted based on SAS score and Candidate Value score.

FIG. 5 depicts the Administrator Interface 51 or Admin Interface. This interface 51 is generally comprised of four general areas or modules: overall candidate tree 52, finance system 53, system reports 54, and Access Level Controls 55. This interface is generally adapted for use by a system administrator or other person with administration privileges to the system.

Preferably the Admin Interface 51, may allow a user to search for candidates, looks for leads, assign leads to sales consultants, look at finance reports, flash job to candidates, add/update new candidate or existing candidates.

Preferably, the Overall Candidate Tree module 52, may allow the user to conduct any of the following actions using the system: View overall job tree subarea wherein the user may be able to view overall tree of candidate IDs through this sub area; Search candidates subarea wherein the user is able to search candidates based on candidate-ID (which is generated when candidate registers) and administrator will be able to see candidate details, skills and its network tree; Update Candidate Details subarea wherein the user may be able to update details of selected candidates; Create new Candidates subarea wherein the user may be to create new candidate based on request received using offline mode.

The Finance System module 53, may be adapted and modified to allow the user to track invoices, payments, overdue accounts and taxes (where applicable). Reports may also be generated of relevant financial information and data over a predetermined time interval.

The System Reports area 54, may allow the user to generate or view all or at least some of the system level reports and these may include: Finance reports area—Various finance reports for the whole system to be generated which would integrate invoice system with points redeemed by candidates; Point Tracking report area—This report may track the points or credits awarded or issued by the system, redeemed by each of the candidate; and Invoice Tracking area—In this area, the user will be able to track pending invoices and make comparisons to payments made.

In respect of the Access Level Controls 55, the user may be granted control in the system over the Recruiter, Candidate and Skill Assessment interfaces. The user may be granted access and privileged to all features of recruiter, candidates and skill assessment interfaces. In respect of the Candidate Skill Assessment—For each candidate skill assessment to be done and correct fields (which are predefined for every job category) to be updated. This may be used by the Recruiter to search right candidates for a specific role. This can also be done from Recruiter and Skill Assessor interface and Pre-existing fields in each job category to be added which can be updated by admin or skill assessor. In respect of the Sales lead tracking, the user may control: Customer relationship management interface to track all the leads generated by the system; and also all the leads assigned to recruiter/franchises may be tracked.

FIG. 6 depicts an example of a referral tree relative to candidates. On top of the referral tree is the system itself or the administrator user located at position 62. The system initially invited some key users or candidates and these are shown at position 63. Typically, the user of the candidate system is depicted at location 63 near to the top of the referral tree 61. The user 63 has invited several second tier candidates to join the system and they agreed. The second tier candidates are located at location 64 and in this example two second tier candidates are shown. The second tier candidates 64 then invited a further tier of candidates and this next tier become third tier candidates 65. Fourth tier candidates 66 were invited by third tier candidates 65. In this example, the system continues forming a referral tree by linking associated and invited candidates along the lines of the referrals sent to them. Theoretically, there is no limit to the amount of tiers that may be generated to form the referral tree. In this example, a hypothetical fifth tier candidate was placed or employed by a recruiter or employer.

FIG. 11 depicts the point or credit system calculation screen used to calculate consideration paid to referring parties. In this embodiment, all parties forming part of the referral tree and in the linkage chain to the top most position receive some form of consideration. The consideration may take many forms include: cash, credits or points. The credits or points may be used as currency within the system or traded for preapproved external service providers.

The screen 110 shown in FIG. 11 depicts the basic elements of the consideration or payment system. This screen sets out the pay-out percentages of referral fee. Generally, the referral fee is a predetermined set amount and this divided amongst the qualifying referring candidates. The screen 110 is adapted to calculate and populate the fields once the CALCULATE button is depressed on the screen.

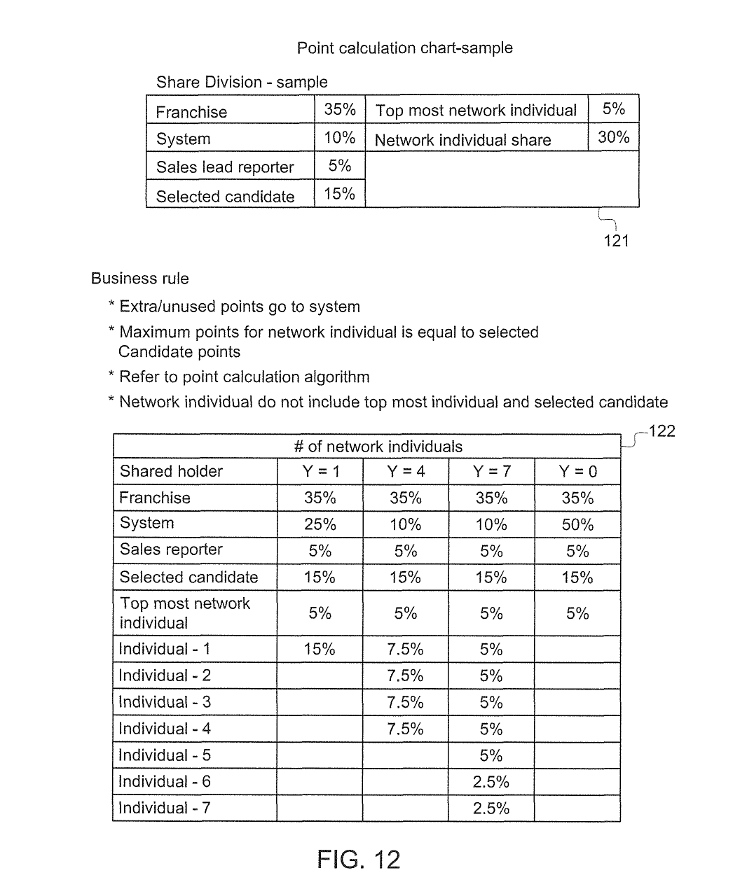

A hypothetical worked example of point calculation is depicted in FIG. 12. Section 121 of the screen depicted in FIG. 12 shows a sample of share division of the points or credit reward on a percentage basis. The network individual share depicts the percentage share of the consideration to be attributed to the qualifying members of the referral tree.

Sub-screen 122 depicts the breakdown of percentage shares allocated to qualifying individuals within the selected referral tree. Preferably, the percentage of consideration is split between qualifying members. However higher percentages are paid to generally higher positions on the referral tree.

Algorithms

The following description defines the preferred means and methods of calculating the algorithms, calculations and scores referred to this specification:

Points Calculation Algorithm

Preferably, the points or credits are awarded by the system to referring people or persons according to the following calculations, rules and assumptions:
Extra/Unused points go to System
Maximum point for Network Individual cannot be greater than selected Candidates points
Network Individual do not include Top Most network individual

The Key variables for this algorithm may include: (Note: levels are calculated from bottom to top)

1. SystemlPortal Share-a%

2. Franchise/Recruiter share-b%

3. Sales lead reporter share-c%

4. Candidate (who gets job) Share-d%

5. Topmost network individual-f%

6. Total Direct Networked Individuals share-g%

7. # of direct levels (excluding topmost and candidate)=y%

Algorithm for calculation of percentage points for individual (IND)
If y>5 and IND is between level 1-5 directly connected to candidate
P1 = (INTEGER Division (g/y))+1)
Elseif y>5 and IND is between level 6- topmost directly connected to
candidate
P2 = (g − 5*P1)/y−5
Elseif Y<5
P3 = g/y
Till P3 >=d
{
d = d+2.5
f = f+2.5
g = g−5
P3 = g/y

The following is an example of the algorithm applied to hypothetical data:

Scenarios -1 - Where y = 11 levels and IND is at level 6
1. System/Portal Share - 10%
2. Franchise share - 35%
3. Sales lead reporter share - 5%
4. Candidate (who gets job) Share - 15%
5. Topmost network individual - 5%
6. Direct Networked Individuals share - 30%
Answers
P1 = 30/11 + 1 = 3
P2 = (30 − 15)/6 = 2.5
Scenarios -2 - Where y = 7 levels and IND is at level 7
1. System/Portal Share - 10%
2. Franchise share - 35%
3. Sales lead reporter share - 5%
4. Candidate (who gets job) Share - 15%
5. Topmost network individual - 5%
6. Direct Networked Individuals share - 30%
Answers
P1 = 30/7 + 1 = 5
P2 = (30 − 25)/2 = 2.5
Scenarios -3 - Where y = 3 levels and IND is at level 2
1. System/Portal Share - 10%
2. Franchise share - 35%
3. Sales lead reporter share - 5%
4. Candidate (who gets job) Share - 15%
5. Topmost network individual - 5%
6. Direct Networked Individuals share - 30%
Answers
P3 = 10
Scenarios -4 - Where y = 1 levels and IND is at level 1
1. System/Portal Share - 10%
2. Franchise share - 35%
3. Sales lead reporter share - 5%
4. Candidate (who gets job) Share - 15%
5. Topmost network individual - 5%
6. Direct Networked Individuals share - 30%
Answers
P1 = 10

Skill Match Algorithm

The skill match algorithm is preferably calculated as part of the Skill Assessor interface 31. The preferred calculation, steps and processing assumptions are herein described in relation to this algorithm:

Step-1—Assessor update skill ratings

For each skill category in the system there will be sub categories defined. For each of these sub-categories there will be rating on a scale of 1-10.

For instance for Software Quality and Testing category there can be sub-categories like
Overall Testing experience
Functional Testing
User acceptance testing
Datawarehouse testing
Test Automation tools
Performance testing
HP QTP
Selenium
Tosca
Lead Test Team
Test management

Assessor based on resource profile, call or face to face interview will update skill rating. These ratings will be updated in the system. Further details are shown regarding these ratings, scores and values in relation the FIGS. 7 to 11 of the accompanying figures.

Step2—Recruiter search

When recruiter searches for candidate he can search based on key criterion needed by client. For instance, if recruiter is looking for a candidate with overall experience of 4+and experience in using tool HP QTP with a rating of 9 or 10, recruiter can easily find that person within the system based providing correct search criterion.

When recruiter gives this search a SAS score will be calculated based on how many parameter match the score. Higher the number of matches, higher the score.

For instance if recruiter searches for above criterion and there is a candidate who has 3+years of experience and rating of 9 In QTP, he will be given 5 points for criterion match for HP QTP and 3 points for overall experience as he did not completely match the criterion. So he gets a SAS rating of 8.

If there is another candidate who has 5 years of experience and 9 rating in HP QTP, he will get SAS rating of 10. Preferably the recruiter then identifies and chooses the most preferred candidate. The recruiter searches are generally referred to and depicted within the preferred embodiment of the present invention in relation to FIGS. 7 to 12.

Step3—Recruiter update/downgrade rating

Recruiter if required can either downgrade the rating of candidate based on client feedback or he can ask assessor to re-skill the candidate if he/she feels candidate has good skills.

Real-time Availability Status Update Method

A significant issue problem with candidates is that it is hard to find or detect when the specific candidate will be available and finish their current assignment especially if they are contracting. But usually recruiters are not able to reach correct candidates leading to waste of their time and effort.

As part of initial profile information, the system may ask for candidate Linkedin™ details (just username) or details of some other social media based internet website; and link those users to its System Linkedln profile. Once linked, system will automatically run a software job to check if candidate status has changed on his role. If yes, an automatic email will be triggered to the candidate to update his profile in system and by default his status will be set to ‘under observation’

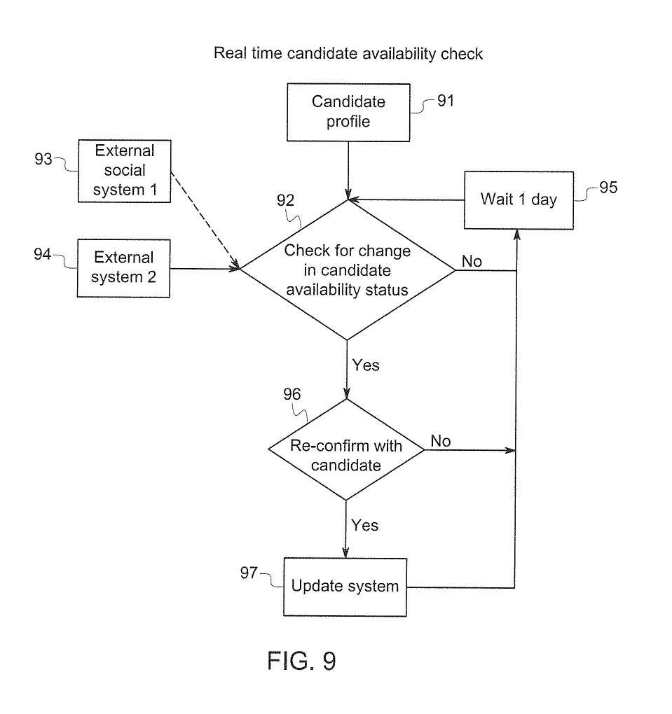

FIG. 9 depicts the system methodology in relation to checking and confirming candidate availability. The candidate profile 91 stores information and data about the current status of the candidate in relation to whether they are currently looking for work opportunities and preferably information about possible or likely start dates for new employment offers. The system may preferably automatically update this information from linked social media websites 93 or from other external systems 94. If there is no change, the system waits for a predetermined period of time elapse 95 (in this example—1 day). If yes, the system reconfirms the data changes with the candidate in step 96. If the candidate agrees, the system will update the information as step 97.

Smart JobFlash Method

Most of the recruiters send mass email campaigns to registered users with them when they get a need. Lot of candidates who apply do not match the criterion and recruiter has to go through painful process of opening the resume and reject the candidate

To generally improve this mass email, recruiter may be more selective in this mail campaigns if he knows list of relevant candidates. The selectivity may be effected by using SAS score to create a short listing process, Recruiter may send mass email to candidates who match the criterion so that only relevant candidates reply to him.

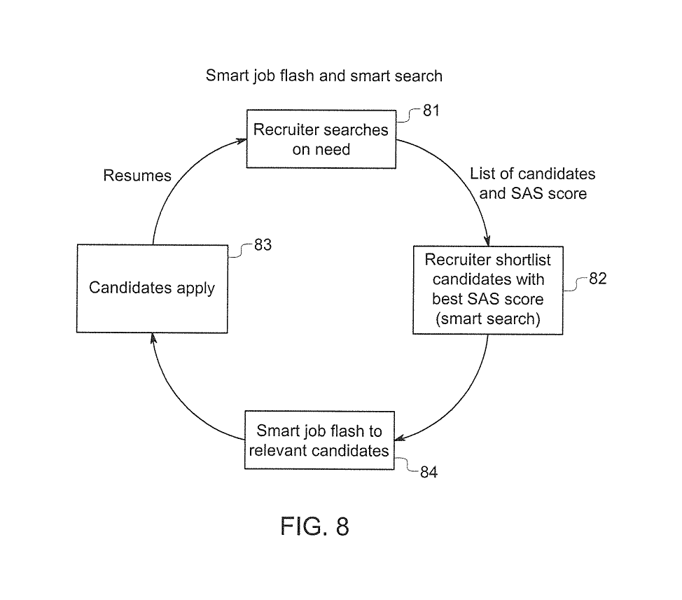

FIG. 8 generally depicts the system methodology relating to the Smart Job Flash and Smart Search capabilities of the system. The system starts with the recruiter generally requiring a search 81. The system produces a list of possible candidates based on the candidate profiles stored in its databases. The recruiter then shortlists the preferred candidates which are usually chosen based on the SAS score or Candidate Value Scores 82. The search step 82 may be named Smart Search.

The recruiter is then given an option by the system to Smart Job Flash the short listed candidates at step 84. The Smart Job Flash is preferably a computerised system of contacting the shortlisted candidates with the job opportunity and asking them to formally apply.

The next step 83 is for the shortlisted candidates to apply for the job opportunity and the recruiter employs the most suitable candidate.

Smart Resume Screening Method

As part of Smart resume screening algorithm, once a candidate within the system replies to job flash posted to them, recruiter interface will automatically match the candidate profile against their skill assessment score and add them to 2 separate buckets. First bucket is of high priority candidates who fit into the skill assessment score and second category of candidate who do not fit into the skill assessment score. Resumes will be matched using the SAS score.

Candidate Value Score

Often along with the SAS score (skill match score), recruiter may also require to know which candidate will give them more value in terms of business benefit. Candidate whose skills match the best and recruiter can get at lowest rate will have the best score value. Also another factor important for the calculation will be is the feedback received from client.

The calculation of SAS Score is depicted in detail in FIG. 7, wherein the first step 71 is for the skill assessor to enter a numerical assessment of predetermined skills based on a grading of 1 to 10. The skills are preferably sorted into subcategories to cover multiple fields or skillsets of the most candidates.

Preferably, the next step 72 is for the recruiter to search the databases of the system by setting minimum threshold values for certain skills for which they are looking for in a preferred candidate. The next step 74, the system calculates an aggregated score based on the preferred skillsets chosen by the recruiter and the aggregated and averaged score forms the SAS Score. In the example shown in FIG. 7, the SAS score is scored out of 10 marks however other maximum mark limits are possible including 100 or 1000.

In FIGS. 10, the candidate value score procedure or process is depicted and described. Preferably, the recruiter conducts a search for candidates 100. The system reports a list of candidates with SAS scores 101, and then the recruiter is allowed by the system to short list the candidates based on the candidate value score 103. The candidate value score preferably includes the capacity to grade candidates based on the any of the following field or combinations thereof: SAS Score, resource cost, local experience and previous client feedback (which may also be stored in the candidate's profile). The recruiter may then select the most preferred candidate 102 and employment may commence.

### Preferred Features of the First Embodiment

Preferably, the candidate may initially register their resume as part of their profile. The Candidate may then refer more candidates into the database who can then refer more candidates forming a multi-level tree or referral tree. In this way tree of job candidates is formed with the first candidate at the top of the tree.

When a recruiter or an employer instruct the system for right candidates for a particular job opportunity, this user searches for candidates in the system's database. Once the candidate is selected, generally 50% of the overall profit will be kept by system and remaining 50% will be distributed between qualifying people or persons within linked within the referral tree in terms of points based on an incentive based algorithm. In this way not only the specific candidate employed earns but also the individuals who have referred the candidate to the system will earn on this placement (candidate Employment and Candidate network or referral tree).

Points earned by candidates may be redeemed in form of training services or royalty at a predetermined time. For the sales, candidates can refer a lead to the portal and they further get paid extra 5% for providing the lead on closure which is part of overall inventive.

Preferably, this system may be integrated with other training providers so that its points or credits can be redeemed for discount vouchers by their system.

In their profile, candidates will be able to setup their skills and rating in each of the known category. Skill assessment may be completed by technical experts in their respective fields and system updated for future needs. Preferably, automatic Candidate Skill assessment mechanism will help searching of candidates innovatively based on their skill assessment score (SAS) algorithm.

Another challenge with previous recruitment system has been the ability to get real-time candidate availability check of candidate on when he is next available. System will be integrated with social platforms like Linkedln™ to get real-time update on candidate availability status. It will also send auto mailer to candidates if there existing status is not updated within the system. This will help recruiter when they are looking for candidate to make sure they find right candidates.

The preferred system may also include the Smart resume screening algorithm, once a candidate within the system replies to job flash posted to them, recruiter interface will automatically match the candidate profile against their skill assessment score and add them to 2 separate buckets. Preferably, the first bucket may be of high priority candidates who fit into the skill assessment score and second category of candidate who do not fit into the skill assessment score.

Another challenge may be that with recruiters may need to direct their job opportunities to specific candidates. Preferably, the recruiters may flash jobs (email campaign or advertisement) to right candidates so that they get only relevant profiles. As part of Smart Job flash algorithm, mass email campaigns are going to be addressed to candidates who fit into skill assessment score requirement for that specific role.

Also included is Candidate Value Score algorithm which may preferably shortlist candidates by fitting them into the criterion which gives best value for money for client and recruiter. The preferred system may be also suitable for franchises to access across to the world who can manage individual recruitment areas globally.

Preferably, the Job Flash interface may flash job to registered candidates for jobs posted within JobTree and jobs posted on other online sites like seek.com.au, monster.com

Innovative Algorithm using which redeemable points will be distributed to all the individuals and candidate in the network tree or referral tree

Skill assessment process and automatic skill assessment score (SAS) calculator which will match resumes with the job need and come

System to link Redeemable points with Training providers and online course providers for further skill enhancement

Real-time candidate availability update feature will immensely help recruiter to know the current status of the candidate when they urgently need resources

As part of Smart Job flash algorithm, mass email campaigns are going to be addressed to candidates who fit into skill assessment score requirement for that specific role

Enhancement and security mechanism of the system with privileges to franchises

Candidate will have option to add multiple profiles (say a Java profile and Dot-net profile) under same candidate id. This will be score independently by assessor

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

What is claimed is:

1. A network based referral system for recruitment, comprising: a job profile corresponding to inputs by a first user of said system; an applicant description module which includes data from an applicant description profile corresponding to characteristics of a second user and an applicant referred to the system by the second user; and a database for storing a plurality of said job profiles and for receiving said applicant description profile over said network and for matching characteristics of said applicant description profile with corresponding characteristics of said job.

2. The system according to claim 1, wherein the system is adapted to allow the second user to invite an applicant to be linked to the application description profile.

3. The system according to claim 1, wherein the system is adapted to accept job applications from either second user or applicant.

4. The system according to claim 1, wherein the characteristics include: contact details, a skills list, an expertise list, and a testing result profile.

5. The system according to claim 1, wherein the application description profile includes a referral tree that includes data on a plurality of applicants known to the second user and referred to the system by the second user.

6. The system according to claim 1, wherein the system includes an authentication procedure to verify the relationship between the second user and applicant.

7. The system according to claim 1, wherein the applicant is a third party and not the second user

8. The system according to claim 1, wherein the system provides consideration to a second user wherein an applicant linked to the application description profile is employed by the first user.

9. The system of claim 8, wherein the consideration payable to a second user is in the form selected from the following group: points, credits, currency or remuneration prizes.

10. The system according to claim 1, wherein the system is adapted to allow the applicant to invite a second tier applicant to be linked to the application description profile.

11. The system according to claim 10, wherein the system is adapted to accept job applications from the second tier applicant.

12. The system according to claim 10, wherein the application description profile includes a referral tree that includes data on a plurality of second tier applicants known to at least one applicant or the second user and referred to the system by the at least one applicant or the second user

13. The system according to claim 10, wherein the system provides consideration to both the second user and the applicant wherein the second tier applicant linked to the application description profile and the second tier applicant is employed by the first user.

14. The system according to claim 10, wherein the system provides consideration to a second user and the applicant at a differentiation rate.

15. The system according to claim 10, wherein the system is adapted to allow the second tier applicant to invite a third tier applicant to be linked to the application description profile.
